(19) United States
(12) Patent Application Publication
(10) Pub. No.: US 2011/0092160 A1
(43) Pub. Date: Apr. 21, 2011

(54) Mobile Device Using Low-Power Radio Link to Headset

(75) Inventors: William O. Camp, JR., Chapel Hill, NC (US); Jacobus Cornelis Haartsen, Hardenberg (NL)

(73) Assignee: Sony Ericsson Mobile Communications AB, Lund (SE)

(21) Appl. No.: 12/581,935

(22) Filed: Oct. 20, 2009

(51) Int. Cl. H04B 7/00; H04M 1/00

(52) U.S. Cl. 455/41.3; 455/556.1

(57) ABSTRACT

A mobile communication device comprises a base unit and a headset in the form of a small, inconspicuous earpiece. The base unit includes a fully functional cellular transceiver and can transmit audio signals over a low power, unidirectional radio link to the headset. The headset unit comprises a unidirectional receiver for receiving audio signals from the base unit and an earphone for converting the audio signals into audible sounds that can be heard by the user.

### BACKGROUND

The present invention relates generally to headset devices for mobile communication devices and, more particularly, to a headset system using a unidirectional link between a base unit and a remote headset.

Bluetooth is a standard for a short-range radio interface for exchanging data over short distances, e.g., up to approximately 30 feet. The impetus behind the Bluetooth standard was to eliminate the need for wires to connect devices that are in close proximity. Common uses for Bluetooth interfaces include keyboards, mice, and headsets for mobile communication devices. The communication link between Bluetooth devices is bidirectional; meaning that each device includes both a transmitter and a receiver. However, bidirectional transceivers consume a significant amount of power and require a relatively large battery. With conventional systems, the relative power consumption between the transmitter and receiver is asymmetrical, with the transmitter using much greater power than the receiver. Given the power requirements for the transmitter, it is difficult to design very small headset or earpieces that fit into a user's ear canal.

### SUMMARY

The present invention relates to a mobile communication device including a base unit and a headset in the form of a small, inconspicuous earpiece. The base unit includes a fully functional cellular transceiver and can transmit audio signals over a low power, unidirectional radio link to the headset. The headset unit comprises a unidirectional receiver for receiving audio signals from the base unit and an earphone for converting the audio signals into audible sounds that can be heard by the user. Because the base unit will typically be larger and have more available power, the transmitter can operate at a normal power level (e.g., in the range of 10-100 milliwatts). However, the low power radio link allows the receiver in the headset to operate at a much lower power level (e.g., a few milliwatts). Using a unidirectional link with a low power receiver in the headset unit, in turn, allows a very small form factor for the headset. Thus, the headset may take the form of a small earpiece that fits into the user's ear canal.

The base unit may, for example, comprise a pen phone that combines an ink pen with communication electronics. In one embodiment, the pen phone may comprise a pen unit having a microphone for converting the user's voice into an audio signal, a conventional cellular transceiver for transmitting the audio signal to a remote device over a cellular network, and a unit-directional transmitter for transmitting audio signals received by the cellular transceiver to the headset.

In another embodiment, the base unit may comprise a pen unit which functions as a relay and a separate modem unit, which may be a conventional mobile phone. The pen unit includes a microphone for converting the user's voice into an audio signal, a short-range wireless interface (e.g. Bluetooth) for sending audio signals to and receiving audio signals from the modem unit, and a unit-directional transmitter for transmitting received audio signals received by the cellular transceiver to the headset.

One exemplary embodiment of the present invention comprises a base unit of a mobile communication device. The base unit includes a microphone and a transmit circuit in the base unit for sending signal over a unidirectional radio link to a remote headset. The transit circuit is configured to generate and send a transmit signal comprising a first frequency component containing the narrowband audio signal spread by the reference signal, combined with a second frequency component containing a frequency shifted reference signal.

In some embodiments of the base unit, the transmit circuit is further configured to generate a wideband reference signal, combine a narrowband audio signal with the reference signal to generate a spread spectrum audio signal, modulate the spread spectrum audio signal onto a first frequency carrier to generate the first frequency component, modulate the reference signal onto a second frequency carrier offset with respect to the first carrier frequency by a first frequency offset to generate the second frequency component; and combine the first and second frequency components to generate the transmit signal.

In some embodiments of the base unit, the reference signal is a constant envelope signal.

In some embodiments of the base unit, the transmit circuit is further configured to combine the first and second frequency components with a third frequency component containing a second narrowband audio signal spread by the wideband reference signal.

In some embodiments of the base unit, the base unit comprises a pen unit containing the microphone and the transmit circuit.

In some embodiments of the base unit, the base unit further comprises a cellular transceiver contained within the pen unit.

In some embodiments of the base unit, the base unit further comprises a modem unit separate from the pen unit. The modem unit contains a cellular transceiver and the pen unit and the modem unit each include a short, range bidirectional radio interface for exchanging signals between the modem unit and the pen unit.

Other embodiments of the invention comprise a method implemented by a base unit for transmitting an audio signal from the base unit to a remote headset over a low power, unidirectional radio link. One exemplary method comprises generating a first frequency component containing a narrowband audio signal spread by the reference signal, generating a second frequency component containing a frequency shifted reference signal, combining the first and second frequency components to generate a transmit signal, and transmitting the transmit signal over a unidirectional radio link to a remote unit.

In some embodiments of the method, the reference signal is a constant envelope signal.

Some embodiments of the method further comprise combining the first and second frequency components with a third frequency component containing a second narrowband audio signal spread by the wideband reference signal.

In some embodiments of the method, the base unit comprises a cellular transceiver, and further comprises receiving the audio signal via the cellular transceiver.

Some embodiments of the method further comprise receiving the audio signal by a cellular transceiver located in the base unit.

In some embodiments of the method, receiving the audio signal via the cellular transceiver comprises receiving the audio signal at a modem unit and transmitting the information to a pen unit over a short-range, bidirectional radio link.

Some embodiments of the method further comprise detecting an audio signal at the pen unit and transmitting the audio signal from the pen unit to the modem unit over the short-range, bidirectional radio link.

Other exemplary embodiments of the invention comprise a remote headset for a mobile communication device. In one exemplary embodiment, the remote headset comprises a receive circuit to demodulate a received signal comprising a first frequency component containing a narrowband audio signal spread by the reference signal, and a second frequency component containing a frequency shifted reference signal, and a speaker cooperatively coupled to the receive circuit for converting the audio signal into audible sounds. The receive circuit is configured to combine the received signal with a frequency-shifted copy of the received signal offset in frequency by an amount equal to the offset between the first and second frequency components; and

In some embodiments of the headset, the receive circuit is configured to multiply the received signal with a frequency offset signal to obtain a frequency shifted received signal, and multiply the frequency shifted received signal with the received signal to despread the audio signal.

In some embodiments of the headset, the receive circuit is configured to multiply the received signal with itself to generate a squared receive signal, and multiply the squared receive signal with a frequency offset signal to despread the audio signal.

Still other embodiments of the invention comprise a method implemented in a remote headset for receiving audio signals from a base unit. One exemplary method comprises receiving a signal over a unidirectional radio link, despreading the received audio signal, and outputting the audio to an earphone. The received signal comprises a first frequency component containing a narrowband audio signal spread by the reference signal, and a second frequency component containing a frequency shifted reference signal. Despreading the audio signal is achieved by combining the received signal with a frequency-shifted copy of the received signal offset in frequency by an amount equal to the offset between the first and second frequency components.

In some embodiments of the receive method, despreading the audio signal comprises multiplying the received signal with a frequency offset signal to obtain a frequency shifted received signal, and multiplying the frequency shifted received signal with the received signal to despread the audio signal.

In some embodiments of the receive method, despreading the audio signal comprises multiplying the received signal with itself to generate a squared receive signal, and multiplying the squared receive signal with a frequency offset signal to despread the audio signal.

### BRIEF DESCRIPTION OF THE DRAWINGS

FIG. 1 illustrates an exemplary embodiment of the present invention comprising a pen unit and earpiece communicating over a unidirectional link.

FIG. 2 shows another exemplary embodiment of the invention comprising a base unit containing a cellular transceiver, a pen unit containing a microphone and communicating with the base unit over a Bluetooth interface, and an earpiece communicating with the pen unit over a unidirectional link.

FIG. 3 illustrates an exemplary transmitter for a unidirectional link between the pen unit and earpiece according to one embodiment.

FIG. 4 illustrates a receiver unit for the unidirectional link between the pen unit and earpiece according to one embodiment.

FIG. 5 illustrates a receiver unit for the earpiece according to another embodiment.

FIG. 6 illustrates a multi-channel transmitter for a pen unit according to one embodiment.

FIG. 7 shows a multi-channel receiver for the unidirectional link according to one embodiment.

### DETAILED DESCRIPTION

Wireless sets for mobile communication devices typically communicate with the handset unit or base unit over a bidirectional link. However, bidirectional transceivers consume a significant amount of power and require a relatively large battery. The present invention provides an alternate architecture for a mobile communication device comprising a base unit and a headset that eliminates the need for a bidirectional transceiver in the headset. Instead, the mobile communication device according to the present invention uses a unidirectional link between a base unit and headset unit having a transmitter located in the base unit, and a receiver located in the headset unit. Because the headset unit no longer includes a transmitter, the headset unit can operate at a much lower power using a smaller battery. Further, the receiver in the wireless headset does not require a high frequency oscillator (VCO) or frequency synthesizer, thereby further reducing the power requirements for the receiver. Consequently, the wireless headset can be made with a very small form factor (e.g. an earpiece) that can fit into the user's ear canal.

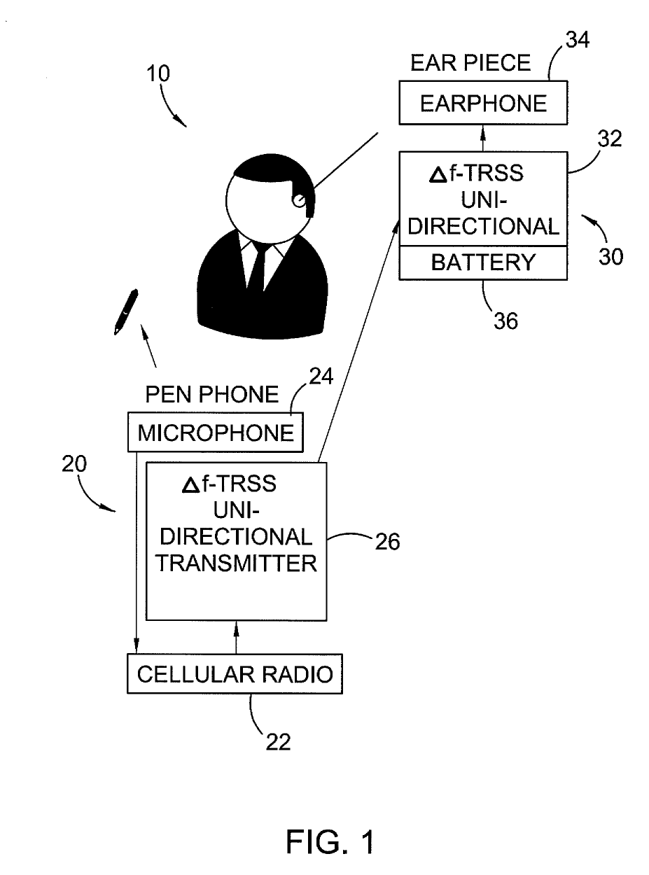

FIG. 1 illustrates a mobile communication device indicated generally by the numeral 10 according to one exemplary embodiment of the present invention. The mobile communication device 10 comprises a base unit 20 in the form of a pen phone, including a pen unit 20 and a remote earpiece 30. The pen unit 20 comprises a writing pen with a fully-functional cellular transceiver 22, a microphone 24, and a unidirectional transmitter 26 for communicating with the remote headset 30. The headset 30, in the form of an in-canal earpiece, comprises a unidirectional receiver 32 for receiving audio signals from the pen unit 20, an earphone 34 for converting the audio signals into audible sounds that can be heard by the user, and a battery 36. Because the microphone 22 is located in the pen unit 20, there is no need for a bidirectional link between the pen unit 20 and the headset 30. Audio signals received by the cellular transceiver 22 are transmitted over the unidirectional link from the pen unit 20 to the earpiece 30, while audio signals detected by the microphone 24 are transmitted to the remote party by the cellular transceiver 26.

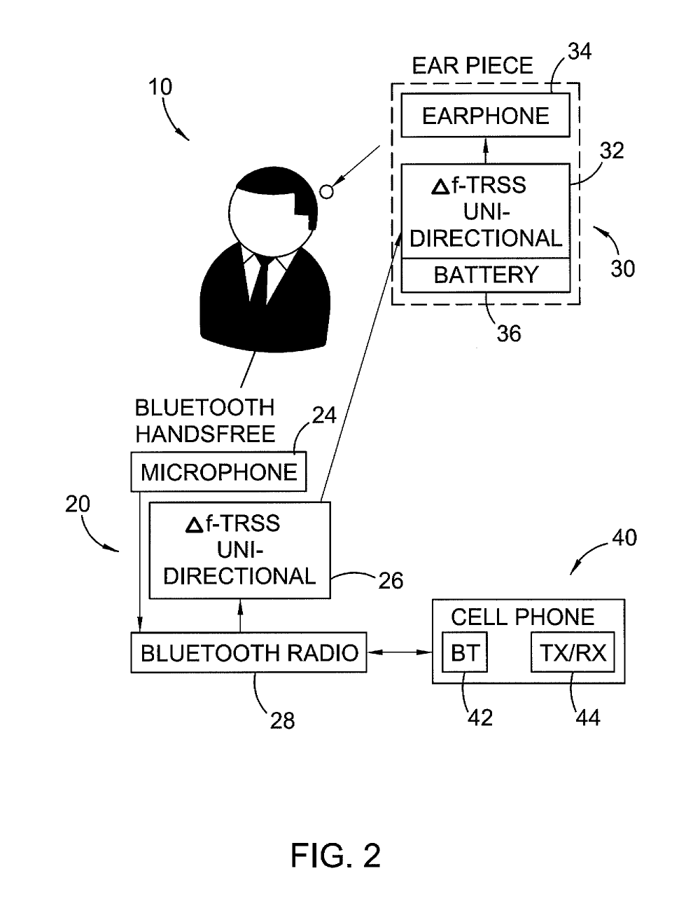

FIG. 2 shows an alternate embodiment of a distributed mobile communication device 10. For convenience, like reference numbers have been used to indicate similar components for the two embodiments. The mobile communication device 10 according to this embodiment comprises a pen unit 20, headset 30, and a modem unit 40. The pen unit 20 includes a microphone 24 and unidirectional transmitter for communicating with the earpiece 30. The cellular transceiver 22 is replaced by a Bluetooth interface 28 for communicating with the modem unit 40. The modem unit 40 includes a Bluetooth interface 42 for communicating with the pen unit 20 and a fully-functional cellular transceiver 44. Thus, in this embodiment, the pen unit 20 functions as a relay for relaying audio signals received from the modem unit 40 to the headset 30. The pen unit 20 also sends audio signals detected by the microphone 24 to the modem unit 40 via the Bluetooth interface 42.

In each of the above-described embodiments, the microphone 24 is located in the pen unit 20 and thus a unidirectional link can be used between the pen unit 20 and the earpiece 30 to transmit received audio signals to the headset 30. In the embodiment shown in FIG. 1, the pen unit 20 incorporates the cellular transceiver 22 and functions as a base unit. In the embodiment shown in FIG. 2, the cellular transceiver 44 is located in a separate modem unit so that the modem unit 40 and pen unit 20 function together as a base unit. However, those skilled in the art will appreciate that other configurations are possible.

A low-power radio transmission system is used for the unidirectional link between the pen unit 20 and headset 30 in order to reduce the power consumption of the headset 30. As described in more depth herein, embodiments of the present invention use a Transmit Reference Spread Spectrum (TRSS) system which applies a frequency offset to separate the reference signal from the audio signal. In contrast to conventional Direct Sequence Spread Spectrum (DSSS) systems where the spreading signal needs to be recreated in the receiver, in the TRSS system, the reference signal used to spread the audio signal is embedded in the transmitted signal. Because the transmit signal contains both the information and reference signals, acquisition and synchronization as required in DSSS systems are not necessary, and thus, the signal can be de-spread instantaneously irrespective of the processing gain. Further, the receiver can be made using a single low-frequency oscillator and two mixers, which results in significant savings in power consumption. The TRSS system is described more fully in pending U.S. patent application Ser. No. 12/501,053 filed on Jul. 10, 2009, which is incorporated herein in its entirety by reference.

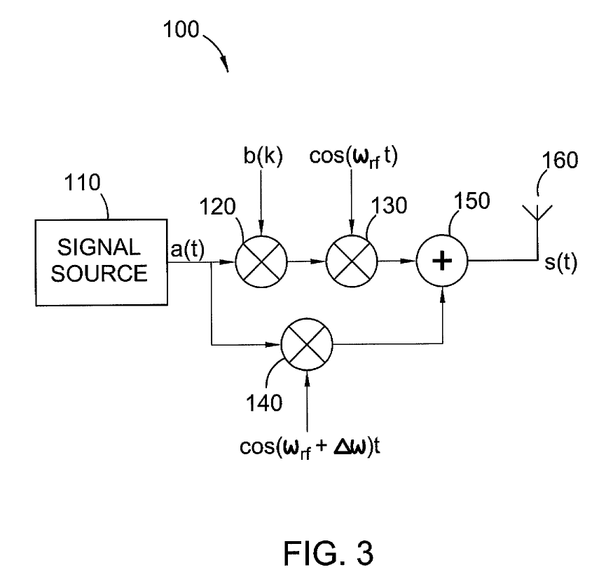

FIG. 3 is a block diagram of a TRSS transmitter 100 for the unidirectional link in accordance with one exemplary embodiment of the present invention. The transmitter 100 includes a signal source 110 to generate a wideband reference signal a(t). The reference signal a(t) may be any signal suitable for modulation by another signal. The reference signal a (t) may be generated at any frequency, such as a specific radio frequency (RF), and can be generated using any electronics, such as a RF voltage controller oscillator (VCO) with reasonable accuracy. It should be understood that the reference signal a(t) can be generated using any other electronics as the present invention is not limited to the reference signal generated by a RF VCO.

In one embodiment, the reference signal a(t) can be generated at baseband or intermediate frequency (IF) and then be up-converted to RF or other desired frequency. The bandwidth (e.g. RF band) of the reference signal 112 can be any desired bandwidth. In one embodiment, the reference signal a(t) can be any RF band, such as any industrial, scientific and medical (ISM) band (e.g., 2.45 GHz). In another embodiment, the reference signal a(t) can be any lower band, such as the FM band from 88 to 101 MHz. It should be understood that the reference signal 112 can be any band of frequencies and the present invention is not limited to only an RF band or FM band.

Multiplier 120 multiplies reference signal a(t) with an audio signal (e.g. audio signal), b(k). This audio signal b(k) can use any modulation scheme, such as BPSK, QPSK, 16-QAM, etc. The mixing of the reference signal a(t) with the audio signal b(k) spreads the audio signal b(k) over the bandwidth of the reference signal a(t) to generate a spread audio signal a(t)*b(k). The spread audio signal a(t)*b(k) is then modulated onto a carrier f=cos(ω_{rf})t by multiplier 130, where ω_{rf} is the carrier frequency. Additionally, mixer 140 modulates the reference signal a(t) onto a second carrier f₂=cos(ω_{rf}+Δω)t to generate a frequency offset reference signal a(t)*cos(ω_{f}+Δω)t, where Δω is the frequency offset between f₁. and f₂. Combiner 150 adds the frequency offset reference signal with spread audio signal resulting in a transmit signal s(t). The transmit signal s(t) is represented by:

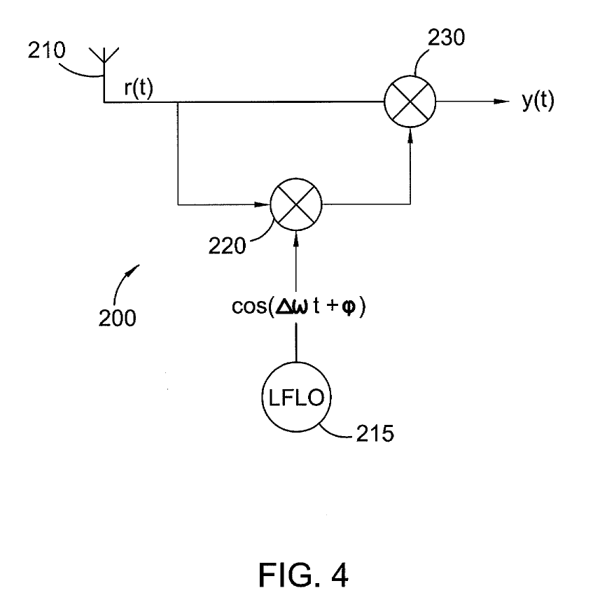

s(t)=b(k)·a(t)·cos(ω_{rf}t)+a(t)·cos(ω_{rf}+Δω)t

Where the term b(k)·a(t)·cos(ω_{rf}t) represents a first frequency component of the transmit signal s(t) containing the spread audio signal and the term a(t)·cos(ω_{rf}+Δω)t represents a second frequency component of the transmit signal s(t) containing a frequency shifted reference signal. Typically, the RF frequency ω_{rf} is in the order of 100 MHz to a few GHz, whereas the frequency offset Δω is in the order of a few kHz or MHz. After the transmit signal s(t) is generated, the transmit signal s(t) may then be transmitted by antenna 160 to a receiver 200, which is discussed below with regards to FIG. 4.

As noted, the bandwidth BWa of the reference signal a(t) is much broader than the bandwidth BWb of the audio signal b(k) so that a spectrum spreading results. In one exemplary embodiment, the reference bandwidth BWa is in the order of tens of MHz. Since the frequency offset Δω is much smaller (e.g., in the order of 1 MHz or less), the spectra of the reference signal a(t) and combined data-reference signal almost completely overlap.

FIG. 4 illustrates an exemplary TRSS receiver 200. The receiver 200 includes an antenna 210 to receive transmission from the transmitter 100. The received signal r(t) at the receiver comprises the transmit signal s(t) convolved with the channel h(t) between the transmit antenna 160 and the receive antenna 210. The receiver 200 comprises a low frequency local oscillator (LFLO) 215 to generate a stable frequency reference and two mixers 220 230. The LFLO 215 generates a frequency reference Δω, which is equal to the frequency offset used at the transmitter 100. Because the receiver 200 is not phase locked with the received signal r(t), the frequency reference Δω from the oscillator 210 may be shifted in phase with respect to the received signal r(t) by an arbitrary and unknown phase offset φ. In the embodiment shown in FIG. 4, mixer 220 mixes the received signal r(t) with the frequency reference Δω+φ to generate a frequency shifted signal x(t). The frequency shifted signal x(t) is represented as:

$$\begin{matrix}x ( t ) = r ( t ) \cdot cos ( Δ ω t + ϕ ) = \\ = \{ b ( k ) a ( t ) \cdot cos ( {ω}_{rt} t ) + a ( t ) \cdot cos ( {ω}_{rt} + Δ ω ) t \} \\ cos ( Δ ω t + ϕ )\end{matrix}$$

Mixer 230 multiplies the frequency shifted signal x(t) by the received signal r(t) to obtain the despread audio signal y(t)=r(t)² cos(Δω+φ). It should be noted that de-spread audio signal y(t) produced by the receiver 200 is a square of the received signal shifted by the frequency offset Δω.

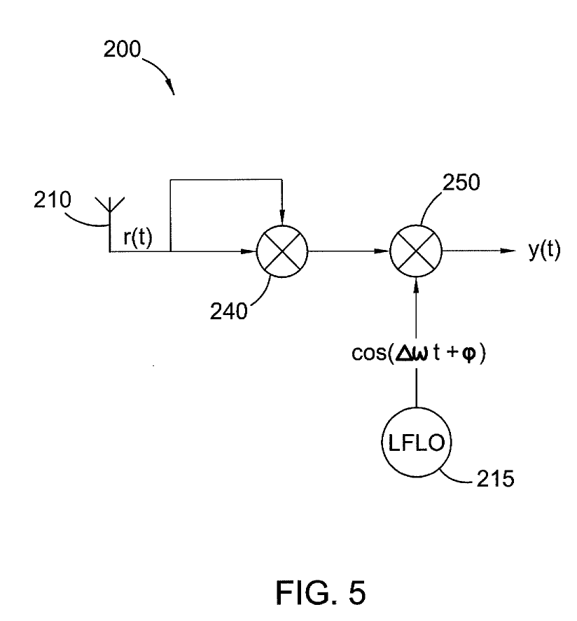

FIG. 5 illustrates another exemplary TRSS receiver 200. For convenience, similar numbers are used in the FIGS. 4 and 5 to denote similar elements. The receiver 200 includes an antenna 210 to receive transmission from the transmitter 100. The receiver 200 comprises a LFLO 215 to generate a stable frequency reference and two mixers 220 230. The LFLO 215 generates a frequency reference Δω, which is equal to the frequency offset used at the transmitter 100. Because the receiver 200 is not phase locked with the received signal r(t), the frequency reference Δω from the oscillator 210 may be shifted in phase with respect to the received signal r(t) by an arbitrary and unknown phase offset φ. In the embodiment shown in FIG. 5, mixer 240 squares the received signal r(t) to generate a squared received signal r(t)². Mixer 250 multiplies the squared receive signal r(t)². by the frequency reference Δω+φ to obtain the despread signal y(t).

It should be noted that the despread audio signal y(t) is the same whether the receiver of FIG. 4 or 5 is used. It should be further noted that the RF frequency ω_{rf} is not generated in the receiver 200, but instead, only the offset frequency Δω. As such, there is no high-power RF local oscillator (LO) included or required in the receiver 200. Furthermore, the reference signal a(t) does not need to be regenerated in the receiver 200 for de-spreading or demodulation of the received signal r(t). In both embodiments, the despread signal can be represented as:

$$\begin{matrix}y ( t ) = {[ b ( k ) \cdot a ( t ) \cdot cos ( {ω}_{rf} t ) + a ( t ) \cdot cos ( {ω}_{rf} + Δ ω ) t ]}^{2} \\ = {b}^{2} ( k ) {a}^{2} ( t ) {cos}^{2} ( {ω}_{rf} t ) + {a}^{2} ( t ) {cos}^{2} ( {ω}_{rf} t + Δ ω t ) + \\ 2 b ( k ) {a}^{2} ( t ) \{ \frac{1}{2} cos ( Δ ω t ) + \frac{1}{2} cos ( 2 {ω}_{rf} t + Δ ω t ) \} \\ = \frac{1}{2} {b}^{2} ( k ) {a}^{2} ( t ) \{ 1 - cos ( 2 {ω}_{rf} t ) \} + \frac{1}{2} {a}^{2} ( t ) \\ \{ 1 - cos ( 2 {ω}_{rf} t + 2 Δ ω t ) \} + b ( k ) {a}^{2} ( t ) \\ \{ cos ( Δω t ) + cos ( 2 {ω}_{rf} t + Δ ω t ) \}\end{matrix}$$

As shown in the equation above, the resulting DC component at the carrier frequency is:

$$\frac{1}{2} \{ {b}^{2} ( k ) \cdot {a}^{2} ( t ) + {a}^{2} ( t ) \}$$

and the component at the offset frequency (Δω) is b(k)·a² (t).

The components that are located at twice the RF carrier frequency (˜2ω_{rf}) may be ignored and thus, can be filtered away (or integrated and dumped) using a filter or like device.

To prevent inter-carrier interference, the spectrum of the squared reference a²(t) should resemble a Dirac impulse. To accomplish this, the reference signal a(t) should produce a constant after squaring. This can be achieved by using a constant envelope function, e.g. a binary function. In one embodiment, if the reference signal a(t) and the information-bearing signal b(k) are binary signals (e.g., +1, −1), the resulting square will be a constant: a²=1,b²=1. In the frequency domain, the DC component

$$( \frac{1}{2} \{ {b}^{2} ( k ) \cdot {a}^{2} ( t ) + {a}^{2} ( t ) \} )$$

of the demodulated data signal is fixed, whereas the de-spread audio signal b(k) (i.e. after de-spreading in the receiver) arises at the offset frequency Δω. This audio signal b(k) is thus extracted from the received signal r(t) without having to generate a reference signal a(t) or via the use of a high-frequency local oscillator. Nonetheless, since the squared reference signal a²(t) at DC is a spike, there is no cross-interference between the audio signal b(k) and the reference signal a(t). Subsequent mixing with the offset frequency Δω will move the intermediate frequency (IF) portion of the signal to baseband where the information-bearing signal b(k) can be retrieved.

If only squaring is applied, the desired de-spread audio signal b(k) will be located at the offset frequency Δω and the audio signal b(k) can be retrieved at IF. Retrieving the audio signal b(k) at IF may be advantageous since greater gains at IF can be obtained. In addition, the unknown or variable phase φ does not need to be retrieved.

In one embodiment, the symbol rate of the de-spread audio signal b(k) and the frequency offset Δω is based on 32 kHz (or other low frequency) which is also used for the real-time clock. The receiver 200 then only needs a low power oscillator (LPO) with a 32 kHz reference from which all clocks in the receiver 200 are derived. The low frequency of the oscillator allows for a low power oscillator to be employed and thus, the receiver 200 becomes a low powered device. In one embodiment, the power of the low power oscillator allows for the peak power consumption of the receiver 200 to be fully operated at 10-100 μW. The reduced power consumption allows use in devices that require a small form factor.

FIGS. 3-5 illustrate a TRSS system with a single channel carrying a single audio signal b(k) in the transmit signal s(t). However, those skilled in the art will appreciate that multiple audio signals can be embedded in the transmit signal s(t) using different frequency carriers for each audio signal. Thus, stereo signals can be transmitted to the remote headset 30.

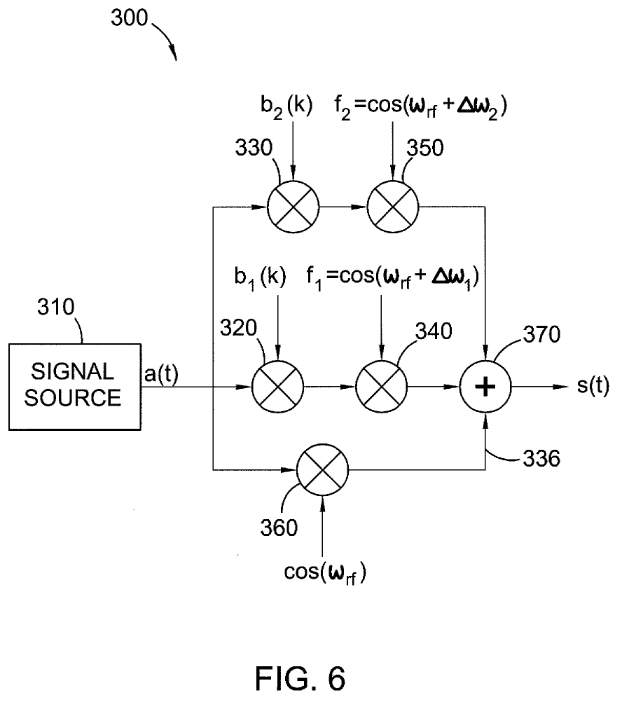

FIG. 6 illustrates an exemplary multiple channel transmitter 300 in accordance with an embodiment of the present invention. The structure of the multi-channel transmitter 300 is essentially the same as the single channel transmitter 200, except that an additional branch is added for each additional audio signal. The exemplary embodiment shown includes two audio channels, but can be extended to as many channels as desired. A signal source 310 generates a wideband reference signal a(t) as previously described. Mixers 320, 330 multiply the reference signal a(t) by respective audio signals b₁(k) and b₂(k), which spreads the audio signals b₁(k) and b₂(k) across the spectrum of the reference signal a(t). The modulation schemes for b₁(k) and b₂(k) may not necessarily be the same. For example, the modulation scheme for b₁(k) may be BPSK while the modulation schemes for b₂(k) may be QPSK.

Mixers 340, 350 modulate the spread audio signals a(t)*b₁(k) and a(t)*b₂(k) onto respective frequency carriers f₁=cos(ω_{rf}+Δw₁) and f₂=cos(ω_{rf}+Δω₂) to generate the information bearing frequency components of the transmit signal s(t). Mixer 360 modulates the reference signal a(t) onto a third frequency carrier f₃=cos(ω_{rf}), which is offset in frequency from the frequency of f₁ by Δω₁ and from the frequency of f₂ by Δω₂. Combiner 370 adds the outputs of mixers 340, 350, and 360 to generate the final transmit signal s(t). The transmit signal is thus represented as:

s(t)=a(t)cos(ω_{rf}t)+b₁(k)·a(t)·cos(ω_{rf}+Δω₁)t+b₂(k)·a(t)·cos(ω_{rf}+Δω₂)t

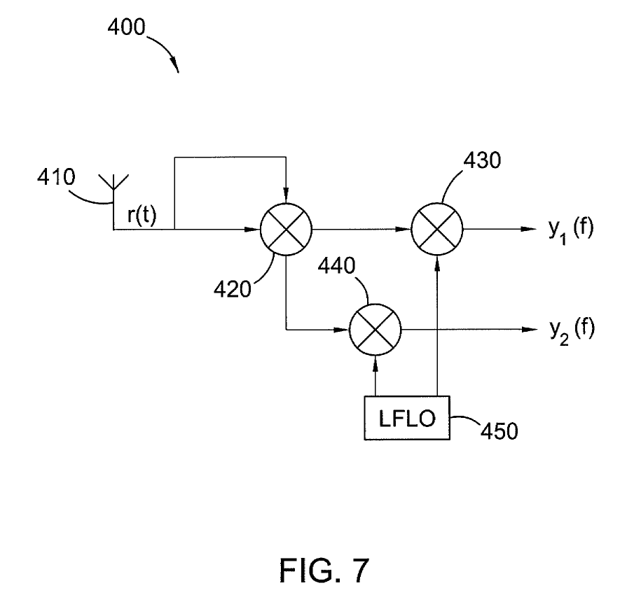

The transmit signal transmit signal s(t) may then be transmitted by antenna 370 to a receiver 400, which is discussed below with regards to FIG. 7. The optimal signal-to-noise ratio (SNR) is obtained when Δωᵢ=πn/T_{b}, where T_{b} is the symbol period of the data signal bᵢ(k) and n an integer (e.g., n=1,2 for 2 channels). The index i indicates one of the audio signals bᵢ(k).

Because of the non-linear, squaring operation of the received signal r(t), self-interference will arise due to the inter-modulation mixing of different components of r(t). To avoid undesirable inter-modulation products, combinations of additions and/or subtractions of the offset frequencies should not be equal to any of the offset frequencies themselves (i.e., Δωᵢ±Δωⱼ≠ωₖ, where i, j, k=1, 2, 3, . . . n for n parallel channels). This limitation can, for example, be realized by selecting odd harmonics (e.g., 1 MHz, 3 MHz, 5 MHz . . . 2 m+1 MHz) for the offset frequencies for the audio channels. After squaring, the inter-modulation products due to self-interference will then end up at even harmonics (e.g., 0 MHz, 2 MHz, 4 MHz, 6 MHz, . . . 2 m MHz) which are not on any of the audio channels. Other combinations are possible that equally prevent inter-modulation.

As an example, a TRSS system operating in the FM broadcast spectrum (88-101 MHz) could have a RF center frequency of ω_{rf}=98 MHz and a spreading bandwidth (BW) of 16 MHz. Assuming an information rate (R) of R=32 kb/s (based on the typical frequency of 32 kHz of a Real-Time clock), the offset frequencies could be chosen to be Δω₁=5R=160 kHz, Δω₂=8R=256 kHz, and Δω₃=11R=352 kHz. Inter-modulation products due to self-interference as the square thereof will arrive at f=3R=96 kHz, f=6R=192 kHz, and f=10R=320 kHz, each of which is adjacent to the desired signals. Furthermore, inter-modulation products caused by strong FM broadcast signals may arrive at f=200 kHz, f=300 kHz, f=400 kHz, and so on. The latter is based on the fact that the FM channel spacing is 100 kHz with at least a minimum separation of 200 kHz between adjacent FM channels. Also these inter-modulation products will be outside the bands of interest.

As another example, a TRSS system operating in the 2.4 GHz ISM spectrum could have a RF center frequency of ω_{rf}=2441 MHz and a spreading bandwidth of 80 MHz. Assuming the same information rate of R=32 kb/s, the same offset frequencies can be selected, as indicated in the above example. All radio standards operating in the 2.4 GHz ISM band have a channel grid and spacing of at least 1 MHz. The first inter-modulation product after squaring will be at 1 MHz which is well above the offset frequencies presented.

FIG. 7 illustrates an exemplary multi-channel receiver 400 for receiving two audio channels. As illustrated in the exemplary embodiment, mixer 420 squares the received signal r(t) from antenna 410. Mixers 430 and 440 multiply the square of the received signal r(t)² by respective frequency offsets Δω₁ and Δω₂ supplied by a LFLO 450 to obtain despread audio signals y(t)₁ and y(t)₂.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A mobile communication device comprising:
a base unit including a microphone;
a transmit circuit in said base unit for sending signal over a unidirectional radio link, said transmit circuit configured to generate and send a transmit signal comprising a first frequency component containing said narrowband audio signal spread by said reference signal, combined with a second frequency component containing a frequency shifted reference signal.

2. The mobile communication device of claim 1 wherein said transmit signal is further configured to:
generate said wideband reference signal;
combine a narrowband audio signal with said reference signal to generate a spread spectrum signal;
modulate said spread spectrum signal onto a first frequency carrier to generate said first frequency component
modulate said reference signal onto a second frequency carrier offset with respect to the first carrier frequency by a first frequency offset to generate said second frequency component; and
combine said first and second frequency components to generate s.

3. The mobile communication device of claim 1 wherein the reference signal is a constant envelope signal.

4. The mobile communication device of claim 1 wherein transmit circuit is further configured to combine said first and second frequency components with a third frequency component containing a second narrowband audio signal spread by said wideband reference signal.

5. The mobile communication device of claim 1 wherein said base unit comprises a pen unit containing said microphone and said transmit circuit.

6. The mobile communication device of claim 5 wherein said base unit further comprise a cellular transceiver contained within said pen unit.

7. The mobile communication device of claim 6 wherein said base unit further comprise a modem unit separate from said pen unit containing a cellular transceiver, said pen unit and said modem unit each including a short, range bidirectional radio interface for exchanging signals between the modem unit and the pen unit.

8. A method implemented by a base unit in a mobile communication device for transmitting an audio signal, said method comprising:
generating, at a base unit, a first frequency component containing a narrowband audio signal spread by said reference signal;
generating at said base unit, a second frequency component containing a frequency shifted reference signal;
combining said first and second frequency components to generate a transit signal; and
transmitting the transmit signal over a unidirectional radio link to a remote unit.

9. The method of claim 8 wherein the reference signal is a constant envelope signal.

10. The method of claim 8 further comprising combining said first and second frequency components with a third frequency component containing a second narrowband audio signal spread by said wideband reference signal.

11. The method of claim 8 wherein said base unit comprises a cellular transceiver, and further comprising receiving said audio signal via said cellular transceiver.

12. The method of claim 8 further comprising receiving said audio signal by a cellular transceiver located in the base unit.

13. The method of claim 12 wherein receiving said audio signal via said cellular transceiver comprises receiving said audio signal at a modem unit and transmitting said information to a pen unit over a short-range, bidirectional radio link.

14. The method of claim 13 further comprising detecting an audio signal at said pen unit and transmitting said audio signal from said pen unit to said modem unit over said short-range, bidirectional radio link.

15. A remote earpiece for a mobile communication device, said remote unit comprising:
a receive circuit in said remote unit to demodulate a received signal comprising a first frequency component containing a narrowband audio signal spread by said reference signal, and a second frequency component containing a frequency shifted reference signal;
said receive circuit configured to combine the received signal with a frequency-shifted copy of the received signal offset in frequency by an amount equal to the offset between the first and second frequency components; and
a speaker cooperatively coupled to said receive circuit for converting said audio signal into audible sounds.

16. The remote unit of claim 15 wherein the receive circuit is configured to:
multiply the received signal with a frequency offset signal to obtain a frequency shifted received signal; and
multiply the frequency shifted received signal with the received signal to despread the audio signal.

17. The remote unit of claim 15 wherein the receive circuit is configured to:
multiply the received signal with itself to generate a squared receive signal; and
multiply the squared receive signal with a frequency offset signal to despread the audio signal.

18. A method implemented inn a remote earpiece for a mobile communication device, said method comprising:
receiving a signal over a unidirectional radio link, said received signal comprising a first frequency component containing a narrowband audio signal spread by said reference signal, and a second frequency component containing a frequency shifted reference signal;
despreading the audio signal by combining the received signal with a frequency-shifted copy of the received signal offset in frequency by an amount equal to the offset between the first and second frequency components; and
outputting the audio to a speaker in the remote earpiece.

19. The method of claim 18 wherein despreading the audio signal comprises:
multiplying the received signal with a frequency offset signal to obtain a frequency shifted received signal; and
multiplying the frequency shifted received signal with the received signal to despread the audio signal.

20. The method of claim 18 wherein despreading the audio signal comprises:
multiplying the received signal with itself to generate a squared receive signal; and
multiplying the squared receive signal with a frequency offset signal to despread the audio signal.
